(19) United States
(12) Patent Application Publication
(10) Pub. No.: US 2026/0325977 A1
(43) Pub. Date: Oct. 22, 2026

(54) SYSTEM AND METHOD FOR FACILITATING INTENT-DRIVEN SOCIAL INTERACTIONS

(71) Applicant: Ryan Henderson, Charlotte, NC (US)

(72) Inventor: Ryan Henderson, Charlotte, NC (US)

(21) Appl. No.: 19/463,157

(22) Filed: Jan. 29, 2026

Related U.S. Application Data
(60) Provisional application No. 63/755,028, filed on Feb. 6, 2025.

(51) Int. Cl. A63F 13/87; A63F 13/216; A63F 13/798; A63F 13/80; G06Q 10/40

(52) U.S. Cl. CPC A63F 13/87; A63F 13/798; A63F 13/80; G06Q 10/40; A63F 13/216

(57) ABSTRACT

A system and method are disclosed for facilitating structured social interaction within a bounded session by transforming participant-generated content into an anonymous, gamified discovery process. User profile data and interaction intentions are collected, and tailored questions are assigned using a fairness-based randomization process. Participant responses are received, anonymized by dissociating identity information, and redistributed to other participants based on predefined compatibility criteria. Participants engage in virtual or physical environments to identify the author of received responses through structured interactions, after which guesses are evaluated and feedback and scoring are provided. Identity is revealed only upon successful match confirmation, enabling a transition from gameplay to meaningful interpersonal interaction. The disclosed approach reduces approach anxiety, promotes active engagement, and supports diverse social contexts including dating, networking, and general socializing.

### CROSS-REFERENCE TO RELATED APPLICATIONS

This application claims priority from U.S. Provisional Patent Application No. 63/755,028 filed on Feb. 6, 2025, the disclosures and contents of which are incorporated by reference herein in their entireties.

### FIELD OF THE INVENTION

The present invention generally relates to social interaction platforms and digital communication systems, and more particularly to a computer-implemented method and system for facilitating structured social interactions using a game-based framework. The invention pertains to the fields of social networking, multiplayer interaction systems, privacy-preserving data processing, and human-computer interaction, and is applicable to both virtual environments and in-person events for enabling intent-driven, anonymized, and engagement-oriented social connections.

### BACKGROUND

Social interaction in both physical and digital environments often presents significant challenges that limit meaningful human connection. One persistent issue is approach anxiety in social settings, where individuals hesitate to initiate conversations with unfamiliar people due to fear of rejection, social judgment, or uncertainty about how to begin an interaction. The hesitation is particularly pronounced in group events, networking gatherings, and social mixers, where participants may remain disengaged despite a shared physical or virtual space. As a result, many potentially valuable social interactions never occur. Another challenge arises from the inefficient discovery of compatible connections in traditional social environments. The individuals are frequently required to rely on chance encounters, visual cues, or brief exchanges to identify others with shared interests, values, or goals. The randomness makes it difficult to locate suitable connections within limited timeframes, often leading to missed opportunities and shallow interactions. The lack of structured mechanisms to guide discovery contributes to frustration and disengagement, particularly in larger gatherings where the number of potential interactions is high. Additionally, even when the individuals with compatible interests are present in the same environment, there is often a lack of meaningful social context to initiate deeper conversations. Social interactions commonly default to superficial small talk, which can feel forced, repetitive, or ineffective in revealing personality traits, values, or intentions. Without substantive conversation starters, participants may struggle to move beyond surface-level exchanges, limiting the depth and quality of resulting relationships.

In digital contexts, particularly within conventional dating and social networking applications, engagement tends to be passive and low effort. Interactions are frequently driven by rapid visual judgments and minimal user investment, resulting in fleeting connections and limited conversational depth. The passive engagement model can encourage superficial participation, reduce accountability, and diminish the likelihood of forming meaningful relationships. Moreover, the individuals seeking genuine interaction may become disillusioned with environments that prioritize speed and volume over authenticity and effort. Accordingly, there exists a need for improved social interaction frameworks that reduce social anxiety, enhance the efficiency of discovering compatible individuals, provide meaningful conversational context, and promote active, intentional participation. Such solutions should support both physical and virtual environments while encouraging deeper engagement and higher-quality interactions without relying on superficial or passive interaction models.

There are conventional solutions, which continue to rely on either unstructured individual initiative or artificially constrained interactions. Digital dating platforms, while lowering the initial barrier to contact, largely shift the burden of initiation to unstructured text-based communication, which often lacks context, purpose, or guidance. The emphasis on profile imagery and passive swiping promotes superficial evaluation and choice overload, while offering no inherent mechanism to transition digital interest into meaningful real-world engagement. As a result, many individuals experience fatigue, indecision, and disengagement without progressing toward authentic interpersonal connection. In contrast, in-person formats such as speed dating events and interest-based meetups attempt to introduce physical presence and immediacy but fail to adequately address emotional and social friction. Speed dating environments impose uniform and rigid time constraints that do not account for natural conversational pacing or differing compatibility trajectories, while also preserving the discomfort of direct, face-to-face rejection. Interest-based gatherings, although premised on shared affinities, typically lack structured interaction frameworks, leaving participants to navigate approach anxiety independently. Over time, such environments often evolve into closed social clusters, further discouraging participation by new or less assertive individuals.

Game-based icebreakers and anonymous social platforms similarly attempt to reduce initial awkwardness yet fall short of sustaining meaningful engagement. Icebreaker activities tend to be momentary and performative, generating surface-level interaction without continuity or mechanisms to deepen or extend conversations beyond the activity itself. Anonymous confession platforms remove vulnerability by obscuring identity, but in doing so eliminate accountability, compatibility assessment, and any reliable path toward real-world connection. The absence of proximity awareness and identity linkage further limits their ability to facilitate genuine interpersonal relationships. Virtual and video-based interaction models, while offering structure and accessibility, replicate many of the same shortcomings in a digital context. Screen-mediated interactions often diminish emotional resonance, spontaneity, and perceived investment, while technical friction and prolonged screen exposure reduce user engagement. These models fail to recreate the motivational dynamics and situational energy associated with shared physical environments, and they provide no seamless mechanism for transitioning from virtual interaction to in-person connection. Accordingly, existing solutions either prioritize convenience at the expense of depth, or structure at the expense of natural interaction. None adequately integrate structured engagement, compatibility signaling, reduced approach anxiety, and real-world contextual interaction into a cohesive system. There therefore exists a need for a solution that overcomes one or more of these shortcomings by facilitating meaningful, context-aware interactions that naturally progress toward sustained, real-world interpersonal connections while reducing psychological barriers and disengagement commonly observed in conventional approaches.

### SUMMARY

The present invention relates to a method and system for facilitating a structured social interaction game that enables meaningful connections among participants while preserving privacy and encouraging authentic engagement. The invention is designed for use in both virtual and physical environments and supports a variety of interaction intentions, including dating, professional networking, and general socializing. By combining anonymized participant-generated content, preference-based matchmaking, and a game-like discovery mechanism, the invention transforms social interactions into an engaging and privacy-conscious experience.

The system collects user profile information such as name, age, gender, profile image, and stated interaction intentions. These intentions guide the system in tailoring the experience for each participant. Based on the selected intent, the system assigns questions from a curated question bank using a randomization algorithm that ensures fairness and minimizes bias across participants. The questions are designed to elicit genuine, participant-generated responses, ensuring that all answer content originates from real individuals participating in the same event or session, thereby preserving authenticity and relevance. The participant responses are processed through an anonymization mechanism that replaces personally identifiable information with system-generated identifiers. The anonymized responses are encrypted and securely stored to maintain participant privacy. These anonymized responses are then redistributed to other participants according to predefined and user-configurable criteria, such as gender preferences, business interests, or product and domain categories. The participants may dynamically enable or disable these filters, allowing them to control the scope and nature of their interactions.

The present invention facilitates interaction through structured prompts and communication features that operate in both virtual and in-person contexts. In virtual environments, the participants may interact using avatars within 2D or 3D spaces that incorporate location-based proximity features, such as proximity-triggered voice communication or profile image visibility. In physical environments, proximity-based communication features may similarly be used to initiate or enhance interactions among nearby participants. A timer governs each interaction phase to ensure balanced participation and sustained engagement throughout the session. A core game mechanic of the present invention involves allowing participants to guess the identity of the individual who authored a received anonymized response. The participants submit their guesses within the allotted interaction window, and the system evaluates these guesses using a scoring engine. Points are awarded for correct identifications, with optional bonuses for consecutive successes and penalties for incorrect attempts. Leaderboards and performance feedback are generated to motivate continued participation and friendly competition. Upon a correct identification, the system may reveal the identity of the response author, creating a natural transition from anonymous interaction to direct and meaningful connection. The identity revelation provides a sense of closure to the game mechanic and serves as a catalyst for further conversation or relationship development. Additionally, the system analyzes participant behavior, responses, and engagement patterns to generate personalized feedback and recommendations, which may dynamically adjust user preferences and future question assignments to enhance long-term engagement. Thus, accordingly, the present invention provides a privacy-preserving, intent-driven, and game-based social interaction framework that encourages authentic self-expression, reduces social friction, and enables participants to form genuine connections in both digital and real-world settings.

In an embodiment, the present invention discloses a method for facilitating a social interaction game among participants within a bounded session. The method comprising: collecting, by a computing system, user profile data for each participant, the user profile data including at least a name, age, gender, profile picture, and an interaction intention selected from dating, networking, or general socializing; assigning, by the computing system, one or more questions to each participant based on the selected interaction intention using a randomized selection process configured to ensure fairness and reduce assignment bias; receiving participant-generated responses to the assigned questions; anonymizing the received responses by dissociating the responses from participant identities and associating each response with a system-generated identifier; redistributing anonymized responses to other participants within the same session based on predefined distribution criteria; facilitating participant interactions in at least one of a virtual environment or a physical event environment using structured interaction prompts; receiving participant guesses identifying an author of a redistributed anonymized response; and awarding points and providing feedback based on correctness of the participant guesses. The method defines an end-to-end framework for facilitating a social interaction game within a bounded session by collecting participant profile data and stated interaction intentions, assigning intention-specific questions using a fairness-based randomization process, and transforming participant-generated responses into anonymized interaction content. The anonymized responses are redistributed to other participants to initiate structured interactions in virtual or physical environments, followed by guess submission, validation, scoring, and feedback. This approach reduces approach anxiety, replaces passive matching with active discovery, ensures equitable participation, and enables meaningful social engagement across dating, networking, and general social contexts.

In an embodiment, redistributing anonymized responses is performed based on compatibility criteria including at least one of gender preferences, business interests, social alignment factors, or product-related categories. The method specifies that anonymized responses are redistributed based on compatibility criteria such as gender preferences, business interests, social alignment factors, or product-related categories. By introducing compatibility-aware distribution, the system increases the likelihood that received content is relevant to the recipient, thereby improving motivation to engage in the discovery process and enhancing the quality of post-discovery interactions.

In an embodiment, the anonymizing step comprises replacing personally identifiable information with unique system-generated codes and storing a secure mapping between the codes and participant identities. The method further defines the anonymization process by replacing personally identifiable information with system-generated codes and maintaining a secure mapping between codes and participant identities. This mechanism preserves participant privacy during the interaction phase while still enabling accurate verification and identity revelation upon successful match confirmation, thereby balancing anonymity with accountability.

In an embodiment, facilitating participant interactions comprises enabling proximity-based communication features within a virtual two-dimensional or three-dimensional environment. The method covers facilitating interactions in a virtual two-dimensional or three-dimensional environment using proximity-based communication features. Such environments simulate real-world social dynamics by enabling interaction based on virtual distance, which increases immersion, reduces screen fatigue, and promotes organic discovery without requiring direct identification at the outset.

In an embodiment, facilitating participant interactions comprises providing structured prompts in a physical event environment that guide participants to initiate verification interactions with other participants. The method addresses facilitation of interactions in physical event environments through structured prompts that guide participants to initiate verification interactions. By providing a predefined conversational framework, the system lowers social friction, legitimizes repeated approaches, and enables multiple low-risk interactions that collectively build confidence and engagement.

In an embodiment, the method further comprises enabling participants to toggle preference filters to enable or disable specific compatibility criteria prior to redistribution of anonymized responses. The method enables participants to toggle preference filters prior to redistribution of anonymized responses, allowing users to customize compatibility criteria or disable filtering entirely. This flexibility accommodates diverse user intentions and comfort levels while maintaining fairness and ensuring that the hunt-based interaction model remains intact.

In an embodiment, facilitating participant interactions includes activating a timer to regulate a duration of an interaction phase within the session. The method introduces time regulation by activating a timer to control the duration of the interaction phase within a session. Timed interaction windows maintain momentum, prevent stagnation, and ensure balanced participation without imposing rigid or superficial interaction limits typical of conventional speed dating formats.

In an embodiment, awarding points comprises applying bonus points for consecutive correct identifications. The method enhances engagement by awarding bonus points for consecutive correct identifications. Such incentive structures reinforce sustained participation, reward skillful discovery, and introduce positive reinforcement that increases user investment in the interaction process without undermining its social nature.

In an embodiment, the method further comprising analyzing interaction history and engagement patterns to generate recommendations for future sessions. The method extends the method to include analysis of interaction history and engagement patterns generated during sessions. By evaluating participant behavior and outcomes, the system gains insight into effectiveness of prompts, filters, and interaction dynamics, enabling data-driven optimization of future sessions.

In an embodiment, the recommendations include adjusting question categories, preference filters, or interaction parameters to improve engagement in subsequent sessions. The method specifies that generated recommendations may adjust question categories, preference filters, or interaction parameters in subsequent sessions. These adaptive adjustments improve long-term engagement, personalization, and success rates while preserving the core anonymity and hunt-based mechanics of the invention.

In an embodiment, the present invention discloses a system for conducting a social interaction game among a plurality of participants. The system comprising one or more processors, and a memory storing instructions that, when executed by the one or more processors, cause the system to: collect and store user profile data including demographic information and interaction intentions; access a question bank; select and assign questions from the question bank based on participant intentions using a randomized fairness-based process; receive participant-generated responses; anonymize the responses by replacing identifying information with system-generated identifiers; redistribute anonymized responses to other participants according to predefined distribution criteria; facilitate structured participant interactions in virtual and physical environments; receive guesses identifying authors of anonymized responses; and evaluate guesses and generate scoring and feedback outputs. The system defines a computing architecture comprising processors and memory configured to execute the full social interaction workflow, including profile collection, question assignment from a question bank, response anonymization, redistribution, interaction facilitation, guess evaluation, and scoring. This integrated system enables scalable, repeatable deployment of the social interaction game across virtual and physical environments while maintaining fairness, privacy, and structured engagement.

In an embodiment, the question bank includes distinct question sets tailored for dating, networking, and general social interaction contexts. The system specifies that the question bank includes distinct question sets tailored to dating, networking, and general social interaction contexts. Intent-specific question design ensures that responses elicit relevant self-expression, foster trust, and serve as effective conversation starters aligned with participant goals.

In an embodiment, the system further comprises a user profile management module configured to store demographic data, preferences, and interaction intentions. The system introduces a user profile management module that stores demographic data, preferences, and interaction intentions. Centralized profile management enables consistent application of compatibility criteria, verification logic, and personalization across multiple sessions and interaction types.

In an embodiment, the system further comprises an anonymization engine configured to dissociate participant identities from responses and securely maintain identity mappings. The system defines the anonymization engine configured to dissociate participant identities from responses while securely maintaining identity mappings. This engine enforces privacy during discovery while ensuring accurate match validation, thereby supporting the invention's core balance between anonymity and eventual identity revelation.

In an embodiment, the redistribution of anonymized responses is performed using a matching algorithm configured to apply compatibility filters or randomization when filters are disabled. The system specifies that the anonymized response redistribution is performed using a matching algorithm capable of applying compatibility filters or randomization when filters are disabled. This dual-mode operation preserves user choice while ensuring equitable distribution and sustained engagement even in unfiltered scenarios.

In an embodiment, the system further comprises a communication interface configured to support proximity-based voice, text, or avatar interactions in a virtual environment. The system introduces the communication interface supporting proximity-based voice, text, or avatar interactions in a virtual environment. Such interfaces enhance realism, encourage movement and exploration, and facilitate natural social discovery without reliance on static messaging.

In an embodiment, the communication interface is further configured to support structured interaction prompts during in-person social events. The system defines the communication interface as supporting structured interaction prompts during in-person social events. These prompts provide consistent guidance, reduce uncertainty, and ensure that all participants can engage meaningfully regardless of social confidence levels.

In an embodiment, the system further comprises a scoring engine configured to award points, apply bonuses for consecutive correct guesses, and generate leaderboard rankings. The scoring engine is configured to award points, apply bonuses, and generate leaderboards. The scoring engine adds a gamification layer that increases motivation and retention while preserving the invention's focus on genuine social connection rather than competition alone.

In an embodiment, the system further comprises a feedback engine configured to analyze participant engagement patterns and generate personalized recommendations. The system defines the feedback engine that analyzes participant engagement patterns and generates personalized recommendations. By leveraging session data, the feedback engine supports continuous improvement of the user experience and alignment with participant intentions.

In an embodiment, the feedback engine dynamically adjusts user preferences, question selection, or redistribution criteria based on prior session outcomes. The system specifies that the feedback engine dynamically adjusts user preferences, question selection, or redistribution criteria based on prior session outcomes. Such adaptive behavior enables the system to evolve with user behavior, improving effectiveness over time while retaining the essential anonymous discovery and hunt-based interaction model.

Accordingly, the disclosed system and method provide a structured and privacy-preserving approach to social interaction that reduces approach anxiety, promotes active engagement, and facilitates meaningful interpersonal connections across virtual and physical environments. These and other features and advantages of the invention will be apparent from the following detailed description and the accompanying drawings.

### BRIEF DESCRIPTION OF THE ACCOMPANYING DRAWINGS

The novel features which are believed to be characteristic of the present invention, as to its structure, organization, use, and method of operation, together with further objectives and advantages thereof, will be better understood from the following drawings in which a presently preferred embodiment of the invention will now be illustrated by way of example. It is expressly understood, however, that the drawings are for the purpose of illustration and description only and are not intended as a definition of the limits of the invention. Embodiments of this invention will now be described by way of example in association with the accompanying drawings in which:

FIG. 1 illustrates a high-level system architecture for facilitating a social interaction game across virtual and physical environments, in accordance with an exemplary embodiment of the present invention.

FIG. 2 illustrates an overall method flow for conducting the social interaction game, from participant onboarding to scoring and feedback, in accordance with an exemplary embodiment of the present invention.

FIG. 3 illustrates a user profile and preference management workflow for capturing participant information and interaction intentions, in accordance with an exemplary embodiment of the present invention.

FIG. 4 illustrates a question assignment and response anonymization process used to protect participant identity, in accordance with an exemplary embodiment of the present invention.

FIG. 5 illustrates a redistribution process for assigning anonymized participant responses based on predefined preferences, in accordance with an exemplary embodiment of the present invention.

FIG. 6 illustrates an interaction phase enabling participant engagement in both virtual environments and in-person events, in accordance with an exemplary embodiment of the present invention.

FIG. 7 illustrates a guess submission, scoring, and feedback workflow for evaluating participant interactions, in accordance with an exemplary embodiment of the present invention.

FIG. 8 illustrates dynamic adjustment of participant preferences based on prior interactions and engagement patterns, in accordance with an exemplary embodiment of the present invention.

Further areas of applicability of the present invention will become apparent from the detailed description provided hereinafter. It should be understood that the detailed description of exemplary embodiments is intended for illustration purposes only and is, therefore, not intended to necessarily limit the scope of the invention.

### DETAILED DESCRIPTION

The following detailed description is provided for the purpose of illustrating the disclosed embodiments and is not intended to limit the scope of the invention. The invention is capable of being implemented in various forms, and the specific embodiments described herein are to be considered illustrative rather than restrictive.

As used in the specification and claims, the singular forms “a”, “an”, and “the” may also include plural references. For example, the term “an article” may include a plurality of articles. Those with ordinary skill in the art will appreciate that the elements in the figures are illustrated for simplicity and clarity and are not necessarily drawn to scale. For example, the dimensions of some of the elements in the figures may be exaggerated, relative to other elements, to improve the understanding of the present invention. There may be additional components described in the foregoing application that are not depicted on one of the described drawings. In the event such a component is described, but not depicted in a drawing, the absence of such a drawing should not be considered as an omission of such design from the specification.

References to “one embodiment”, “an embodiment”, “another embodiment”, “yet another embodiment”, “one example”, “an example”, “another example”, “yet another example”, and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in an embodiment” does not necessarily refer to the same embodiment.

The words “comprising,” “having,” “containing,” and “including,” and other forms thereof, are intended to be equivalent in meaning and be open ended in that an item or items following any one of these words is not meant to be an exhaustive listing of such item or items or meant to be limited to only the listed item or items. Unless stated otherwise, terms such as “first” and “second” are used to arbitrarily distinguish between the elements. Thus, these terms are not necessarily intended to indicate temporal or other prioritization of such elements. While various exemplary embodiments of the disclosed invention have been described below it should be understood that they have been presented for purposes of example only, not limitations. It is not exhaustive and does not limit the invention to the precise form disclosed. Modifications and variations are possible considering the above teachings or may be acquired from practicing of the invention, without departing from the breadth or scope.

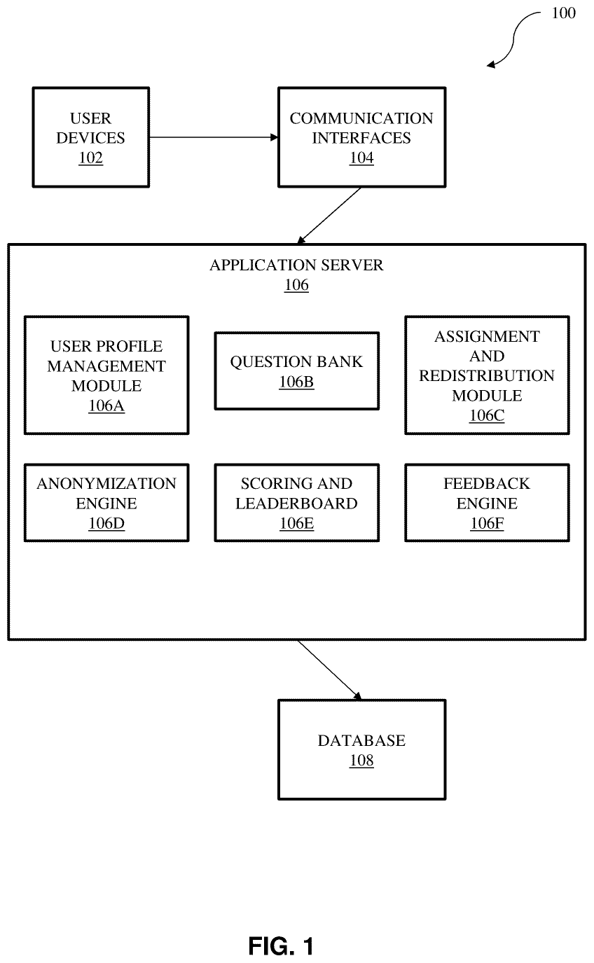

FIG. 1 illustrates a high-level system architecture 100 for facilitating a social interaction game across virtual and physical environments, in accordance with an exemplary embodiment of the present invention. The exemplary system architecture 100 is being shown for facilitating a structured social interaction game that transforms participant-generated answers into motivated interpersonal discovery within a shared session, such as an in-person event (for example, a cafe, social gathering, community event, or team-building activity) or a virtual environment (for example, a 2D or 3D space with proximity-based interactions). In the illustrated arrangement, one or more user devices 102 communicate through one or more communication interfaces 104 with an application server 106 that coordinates gameplay operations and enforces privacy-preserving redistribution. The application server 106 further communicates with a database 108 to store and retrieve participant profiles, questions, answers, anonymization mappings, distribution logs, and session outcomes. The system is specifically suited for social settings in which participants intend to get to know one another through structured interactions, including dating, friendship formation, community engagement, networking scenarios in which the participants seek to build interpersonal trust or alignment, and similar relationship-development contexts, while not being intended for transactional or commercial environments where the primary purpose is direct sales, consultations, or negotiations.

The user devices 102 may include smartphones, tablets, laptops, wearable devices, kiosks, or other computing devices capable of executing a client application or web experience that presents prompts, collects participant input, and supports the interaction phase of the session. In operation, the user devices 102 enable the participants to join a particular session, provide onboarding and profile data, submit answers within a specified time window, receive anonymized answers authored by other participants, and optionally submit verification and match-confirmation inputs during the hunt process. In some implementations, the user device 102 presents a user interface that displays session status, timing controls (for example, round timers), received answer content, and permitted interaction cues, and further supports notification delivery to prompt a participant to answer questions, begin hunting, or submit a guess. In virtual implementations, the user device 102 may additionally render a 2D or 3D environment in which avatars move within a bounded space, where proximity-based interaction rules govern when participants can communicate via voice chat or messaging, and where limited profile attributes (for example, age, profile picture, interests, experience) may be shown to support discovery while preserving the anonymity of the received answer content until a correct match is validated.

The communication interfaces 104 may include one or more networks, gateways, or communication layers that support data exchange between the user devices 102 and the application server 106, such as the internet, a local network at an event venue, a wireless network, or combinations thereof, and may further support real-time notification channels and confirmation acknowledgements. The communication interfaces 104 may implement transport security, session authentication, and message routing for gameplay events, including question delivery, answer submission, anonymized redistribution delivery, and logging of participant acknowledgements that confirm that an assigned prompt or redistributed answer was delivered. In some implementations, the communication interfaces 104 also support event-specific onboarding mechanisms, such as scanning a session code or joining a virtual “room,” to register active players at session initialization and to ensure that distributions and hunts occur within a bounded pool of participants in the same session.

The application server 106 may include one or more processors and memory storing computer-executable instructions that implement the operational logic of the invention, including user onboarding, question assignment, answer submission and storage, anonymization, compatibility-based distribution, hunt-phase management, verification, match confirmation, identity revelation triggers, scoring, and feedback collection. The application server 106 is shown as including a user profile management module 106A, a question bank 106B, an assignment and redistribution module 106C, an anonymization engine 106D, a scoring and leaderboard module 106E, and a feedback engine 106F, each of which may operate independently or cooperatively under a session orchestration workflow. In practical operation, the application server 106 initializes an event session, registers active players, selects and presents questions designed to elicit meaningful self-expression, receives participant-generated answers as the core content currency of the session, strips identifying information to preserve anonymity, redistributes anonymized answers to other participants based on the participant's intention and any enabled preferences or filters, and then supports a hunt phase in which recipients approach others to discover the author through structured verification interactions, culminating in match validation and identity revelation upon successful discovery.

The user profile management module 106A may manage participant onboarding and profile setup, including receiving and storing essential profile data such as a participant name, age, gender, profile picture, and a stated intention associated with the session or platform usage. The intention may represent, by way of example, dating, friendship formation, socializing, networking, investing, seeking investors, or seeking a technical founder, and the system may operate under the assumption that a participant has a specific intention that drives the question selection process and the overall user experience. The user profile management module 106A may further support participant-controlled preference toggles that enable or disable specific filters, such as dating preferences (for example, straight, gay, bisexual), and may store interests, experience, and other profile attributes used to tailor question assignment, guide redistribution criteria, and determine verification methods for confirming correct matches. The user profile management module 106A may also store session participation state, including whether a participant has answered assigned questions, whether a participant has received redistributed answers, whether a participant has submitted guesses, and whether a participant has successfully discovered an author, thereby supporting game integrity and preventing duplicate or conflicting distributions.

The question bank 106B may store a curated set of prompts usable across multiple social environments and use cases, including questions designed to foster meaningful and goal-oriented interactions. In operation, the question bank 106B may support personalized question curation by selecting questions based on the participant's intention and the social environment of the session, such that reflective, nostalgic, and emotional questions are available for social and dating contexts to evoke emotions and foster interpersonal trust, while networking contexts may emphasize prompts regarding growth, achievements, and professional challenges to enable trust-building and alignment discovery. The question bank 106B may also support scenarios in which factual questions are used for buying and selling purposes; however, the system is not intended for transactional environments where the primary goal is commercial exchange, and accordingly the effectiveness of the disclosed session mechanics relies on participant intent to engage in meaningful personal interactions rather than transactional exchanges involving unrelated information. The questions may be assigned according to a randomization algorithm configured to promote fairness and reduce assignment bias across the participant pool, and questions may be presented with timers or round constraints that encourage participation and maintain engagement without forcing superficial interactions in a fixed, linear, one-at-a-time format.

The assignment and redistribution module 106C may implement both (i) question assignment operations and (ii) the flexible answer distribution operations that deliver anonymized answers to other participants to initiate the hunt process. For question assignment, the module 106C may select one or more questions per participant based on the participant's stated intention, session type, enabled preferences, and fairness constraints, and transmit the selected questions to the user device 102 for response composition. For answer redistribution, the module 106C may receive stored answers (after anonymization by the engine 106D) and create a distribution map that assigns each anonymized answer to one or more other participants within the same session, thereby ensuring that participants receive someone else's answer content rather than their own and thereby creating a legitimate need for interpersonal interaction. The flexible distribution may be performed according to specified user intentions and criteria, including, for dating use cases, distribution according to gender preferences and enabled dating filters, for networking use cases, distribution according to similar interests or business-related criteria that support trust-building and alignment, or, when no filter is applied, distribution according to randomization to preserve fairness. The module 106C may generate delivery records and require delivery confirmation acknowledgements to ensure each redistributed answer is received, logged, and available to drive the subsequent hunt, and may further ensure that the distribution occurs only among multiple participants in the same session to preserve the search dynamic in which multiple potential candidates exist and wrong guesses are expected as part of the process.

The anonymization engine 106D may implement an answer-participant dissociation mechanism that separates the received content from author identity until a correct match is validated, thereby reducing approach anxiety, reducing the risk of immediate rejection, and creating the mystery that motivates active participation. In operation, the anonymization engine 106D may process submitted responses by replacing personally identifiable information with system-generated codes and/or removing identifying elements and may store a secure mapping between an anonymized response identifier and an underlying participant identifier in the database 108 with controlled access. In some implementations, anonymized responses and associated identity mappings may be encrypted at rest and during transmission to further protect participant privacy. The anonymization engine 106D may further support answer validation operations to ensure the response is properly formed for redistribution, and may apply content governance consistent with safety features, such as enabling blocking or reporting mechanisms, while maintaining the privacy-preserving requirements of the session. The anonymization engine 106D enables the system to distribute participant-generated content while preserving anonymity during the hunt phase and further enables an identity revelation trigger to occur only after a successful match confirmation event.

The scoring and leaderboard module 106E may implement gamification elements that promote engagement and continuity, including awarding points for correct identifications and optionally providing bonuses for consecutive correct guesses. In operation, the module 106E may receive verification outcomes and match confirmations, compute points based on session rules, update leaderboards, and present participant progress through the user devices 102. The scoring and leaderboard module 106E may also coordinate with time management controls to regulate interaction length, maintain engagement across rounds, and provide structured progression from question answering to hunting to match discovery. In some implementations, the scoring and leaderboard module 106E further cooperates with optional hint or clue logic, for example by enabling progressive hints when a participant experiences repeated unsuccessful guesses, while preserving game integrity and the anonymity constraints until confirmation.

The feedback engine 106F may collect, store, and process feedback associated with the quality of prompts, the perceived compatibility of redistributed answers, participant satisfaction, success rates of match discovery, and other outcome metrics that can be used to optimize question curation and redistribution logic over time. In operation, the feedback engine 106F may solicit participant ratings after a match discovery event or at session conclusion, record whether an interaction transitioned into a sustained conversation, and compute analytics regarding engagement and trust-building effectiveness. The feedback engine 106F may also support administrative or session-host views that summarize aggregate session performance and can be used to tune question types, distribution filters, and round durations for different environments, including in-person events and virtual 2D/3D spaces.

The database 108 may store the user profiles, session records, centralized question bank content, submitted answers, anonymized answer identifiers, distribution mappings, delivery confirmations, verification logs, scoring records, and feedback data. In operation, the database 108 supports the end-to-end method stages including session initialization, question assignment, answer submission within defined timeframes, anonymization and secure mapping retention, redistribution fairness via random number generation where applicable, interaction-phase tracking, guess submission, match validation, identity revelation for both parties upon successful discovery, and analytics and feedback storage. The database 108 thereby supports the essential functional elements of the invention, including participant-generated answer content authored by real participants in the same session, anonymous distribution of those answers to other participants based on perceived compatibility or enabled criteria, an active hunt process that requires participants to approach others using the received answer as a structured, low-risk conversation starter, and a controlled identity revelation trigger that provides closure and transitions the interaction from gameplay to genuine social connection.

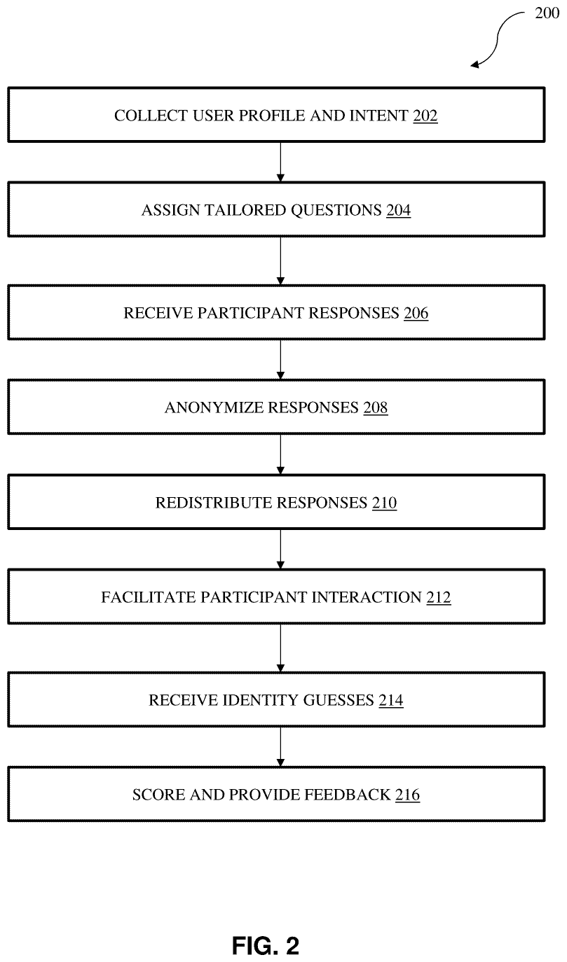

FIG. 2 illustrates an overall method flow 200 for conducting the social interaction game, from participant onboarding to scoring and feedback, in accordance with an exemplary embodiment of the present invention. The example method flow 200 facilitates the structured social interaction game in which participant-generated answer content is anonymized, redistributed to other participants based on intent and compatibility criteria, and then used to drive an active “hunt” process in a bounded in-person or virtual session. In the illustrated flow 200, each block corresponds to a process step that may be performed by, or under control of, one or more application servers (for example, the application server 106 of FIG. 1) in communication with one or more user devices (for example, the user devices 102) and one or more databases (for example, the database 108). Although FIG. 2 shows the steps in a particular order, one or more steps may be performed in parallel, repeated across multiple rounds, or modified in timing (for example, with timers or session control logic) without departing from the described method, provided that the essential elements are preserved, including participant-generated answer content, anonymous distribution to other participants (not to self), a hunt process within a multi-participant session, compatibility-based or criteria-based distribution, and identity revelation upon successful match confirmation.

In step 202 (collect user profile and intent), the system performs onboarding and profile setup for the one or more participants joining a session, such as an event/cafe session or a virtual room. In step 202, the system collects profile data that may include a participant name, age, gender, profile picture, and one or more intentions associated with the participant's reason for joining the session. By way of example, the intentions may include dating, friendship formation, socializing, networking, investing, seeking investors, or seeking a technical founder, and the system may operate under the assumption that a user/participant typically has a specific intention when visiting a website or participating in a session, which intention drives subsequent question selection and the overall user experience. Step 202 may further include receiving user-configurable preference toggles that enable or disable specific filters, such as dating preferences (for example, straight, gay, bisexual), and may include capturing interests, experience, and other attributes usable for compatibility analysis, distribution criteria, and verification. In some implementations, step 202 also includes session initialization operations such as registering active players, associating each participant with a session identifier, and establishing session rules (for example, round timing, number of questions per round, interaction time windows, scoring policies, and any safety constraints such as blocking or reporting availability).

In step 204 (assign tailored questions), the system selects and presents the one or more questions to each participant, where the question assignment is tailored to the participant's intention and the social environment associated with the session. In an example dating or socializing context, step 204 may assign reflective, nostalgic, and emotional questions intended to evoke meaningful memories and foster interpersonal trust, thereby producing answer content that is deeper than purely visual or profile-based matching. In an example networking context, step 204 may assign questions directed to career achievements, growth, and professional challenges such that the participants can learn about one another's development and build trust or alignment, even where the setting is not a transactional or sales-driven environment. Step 204 may be supported by a centralized question bank that maintains curated prompts for different use cases, and the questions may be assigned using a randomization algorithm configured to ensure fairness and prevent systematic bias, including fairness constraints that reduce repeated pairing patterns or repeated prompt exposure. Step 204 may also initiate a timer or response window (if applicable) to regulate the answering phase and maintain session momentum without imposing an artificially short face-to-face conversation window that would force superficial interaction.

In step 206 (receive participant responses), the system receives the participant-generated answers to the assigned questions through an input interface on the user device and stores the received answers in association with the participant identifiers and session identifiers. Step 206 may include validating that a response is received within a specified time frame, confirming submission completion, and storing the content as the core interaction “currency” of the session. The participant-generated nature of the answer content is essential because the answers reflect authentic self-expression, personal experiences, and goals, and thereby serve as meaningful conversation starters and compatibility signals. In some implementations, step 206 may include capturing metadata such as timestamps, round identifiers, and question identifiers, and may log delivery confirmations indicating that a participant viewed the question, started drafting, or submitted the answer, which metadata supports later integrity checks and analytics. Step 206 may also include optional answer validation operations, such as checking that required fields are present or that the content is properly formatted for redistribution, while maintaining the intended privacy and safety posture of the session.

In step 208 (anonymize responses), the system anonymizes the submitted participant responses by dissociating the answer content from the author's identity, thereby reducing approach anxiety and eliminating immediate rejection risk during initial discovery. In step 208, the personally identifiable information may be replaced with system-generated codes and/or removed, and the system may create a secure mapping between an anonymized response identifier and the underlying participant identifier for later match validation and identity revelation. The anonymization is foundational because, without it, the interaction would revert to conventional profile viewing or direct messaging where the risk of explicit rejection is front-loaded and where passive browsing can replace genuine engagement. Step 208 may further include storing the anonymized responses in a secure database, logging anonymization events, and implementing access controls such that only the system's verification logic can resolve the mapping upon successful match confirmation. In some implementations, step 208 is performed in a manner that preserves the semantic content of the response (so the answer remains useful for discovery and conversation) while stripping identity attributes and may operate in cooperation with safety features such as blocking and reporting, without undermining anonymity until a confirmed match event.

In step 210 (redistribute responses), the system distributes the anonymized answers to other participants within the same session based on predefined criteria, thereby ensuring that each participant receives content authored by a potentially compatible unknown participant and thereby triggering the hunt process. Step 210 may implement flexible answer distribution based on user intentions and enabled filters, such that, for dating use cases, prompts are distributed based on gender preferences and selected dating preferences, for networking use cases, prompts are distributed to users with similar interests or business alignment criteria, and, when no filter is applied, responses may be distributed using randomization to preserve fairness. In some implementations, step 210 uses a random number generator and fairness constraints to prevent over-targeting certain participants, prevent repeated distribution loops, and ensure that distribution is not biased toward particular subgroups. Step 210 also preserves the essential requirement that distribution occurs to other participants (not to the author) and occurs within a multi-participant session, because the presence of multiple candidates and the possibility of wrong guesses are part of building investment and perceived value in the discovery process. Step 210 may further include delivery confirmation logging to ensure that each redistributed answer is successfully delivered to its recipient(s) and may create a distribution map record that later supports validation of whether a submitted guess corresponds to the intended author.

In step 212 (facilitate participant interaction), the system initiates and supports the interaction phase in which the participants actively search for the author(s) of the anonymized answers they received, thereby converting passive waiting into active engagement. In an in-person session, step 212 may include presenting structured prompts that instruct recipients to approach other participants and ask a verification question such as “Did you write this?” and may include session rules that encourage multiple mini-interactions without penalizing incorrect guesses, thereby reducing the perceived stakes of each approach. In a virtual implementation, step 212 may include enabling a 2D or 3D virtual space where avatars can move and interact using proximity-based rules, voice chat, or messaging, and where limited profile information (for example, age, profile picture, interests, experience) may be displayed to help guide the hunt without revealing authorship of the anonymized answer. Step 212 may also include interaction timing controls to maintain engagement (for example, round timers or interaction windows), interaction monitoring to track attempts and progress, and optional hint or clue generation logic that can provide progressive guidance while preserving anonymity until a correct match is validated. Step 212 is central to the invention because the hunt process creates effort investment and social momentum, provides a legitimate reason to approach multiple people, and builds perceived value in the eventual discovered connection through the effort expended.

In step 214 (receive identity guesses), the system receives one or more participant guesses that attempt to identify the original author of a received anonymized answer, or, depending on the use case, to identify information related to the author's response based on interactions and observations. In an example implementation, the recipient submits a guess by selecting a participant name from a session roster, selecting an avatar/user identifier in a virtual space, or providing identifying information that the session rules permit for verification. Step 214 may include recording whether the recipient attempted an in-person verification interaction, capturing the time and context of the guess, and storing the guess event for subsequent match validation and scoring. Step 214 may be implemented such that wrong guesses are treated as part of normal gameplay rather than as failures, which reduces rejection pressure and encourages continued interaction, and the system may track repeated attempts to enable optional difficulty adjustment or hint provision while maintaining fairness and session integrity.

In step 216 (score and provide feedback), the system determines whether each submitted guess corresponds to the correct author of the anonymized answer and, upon a correct match, validates the match and triggers identity revelation to both parties to provide closure and transition the interaction from game mechanics to genuine conversation. Step 216 may award points for correct identifications and optionally award additional bonuses for consecutive correct guesses, update a leaderboard, and present progress indicators to participants through their user devices. Step 216 may also generate feedback outputs that confirm correct matches, provide rewards or achievements, and log success validation events, and, in some implementations, may solicit participant feedback regarding the quality of prompts, the perceived compatibility of redistributed answers, and the overall experience, thereby enabling analytics that track success rates and optimize future question selection and distribution. Step 216 also supports the intended post-discovery conversation by enabling the matched pair to use the answer content as a natural conversation starter and shared context, which promotes deeper engagement and trust-building beyond superficial introductions. Thus, in accordance with the above steps, FIG. 2 depicts a complete method cycle that begins with intent-driven onboarding, proceeds through tailored prompt assignment and anonymous redistribution, and culminates in a structured hunt and verified identity revelation within a bounded multi-participant session, thereby addressing shortcomings of conventional systems that rely on unstructured initiation, passive swiping, superficial matching, or limited online-only interaction without seamless transition to meaningful real-world connections.

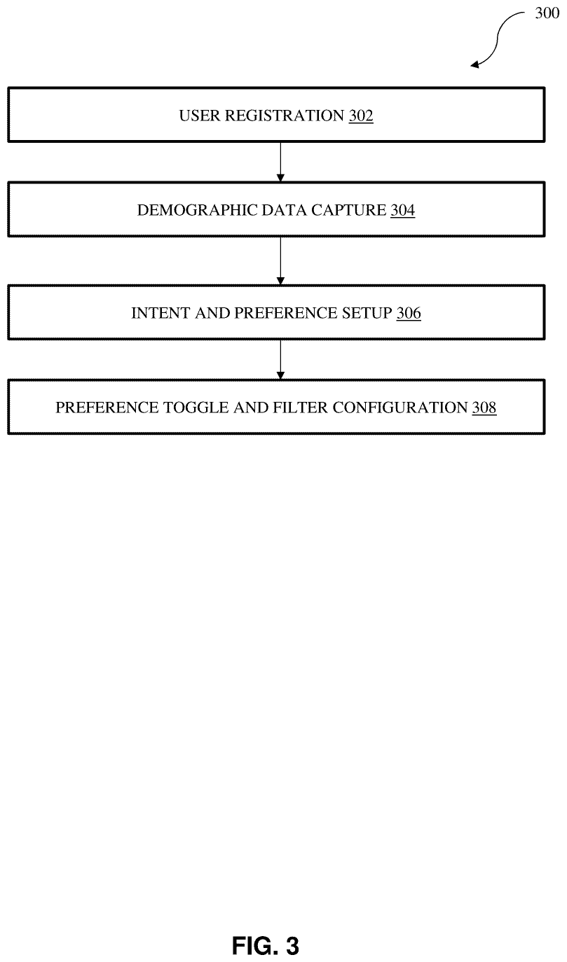

FIG. 3 illustrates a user profile and preference management workflow 300 for capturing participant information and interaction intentions, in accordance with an exemplary embodiment of the present invention. The example onboarding and profile-setup workflow 300 may be performed as part of step 202 of FIG. 2, and more generally by the user profile management module (for example, the module 106A of FIG. 1) in cooperation with the user devices 102 and the application server 106. The steps of FIG. 3 establish the participant identity within a bounded session and collect the intent-driven and preference-driven information used throughout the method, including tailoring question curation, applying compatibility-based or criteria-based redistribution, determining verification formats for match confirmation, and enforcing the session constraints that enable the anonymous hunt process to function as intended in either an in-person social setting or a virtual 2D/3D environment.

In step 302 (user registration), the system registers a participant as an active player for a particular session, which may correspond to an event or cafe session, a community or team-building session, or a virtual environment session. Step 302 may include receiving authentication or session-join credentials (for example, a session code, QR code, invitation link, or virtual room identifier), creating a participant account or session record, associating the participant with a session identifier, and generating a system-side participant identifier that is used internally for tracking and distribution without exposing identity during the anonymous phase. Step 302 may further include presenting terms or participation rules to establish expected behavior in a social interaction environment and to support later safety features (for example, reporting or blocking) while maintaining anonymity until a match is confirmed. In some implementations, step 302 also establishes client-side and server-side communication channels for delivering questions, receiving answers, providing redistributed anonymized responses, and recording delivery confirmations and gameplay events for later scoring and feedback.

In step 304 (demographic data capture), the system captures baseline demographic data that enables the invention to operate across different social intentions and environments and supports both compatibility filtering and verification mechanisms. Step 304 may include collecting the participant's name, age, gender, and profile picture, and optionally collecting other high-level attributes such as general interests, experience, or background information that is relevant to networking or social alignment, while avoiding exposing these attributes as authorship indicators for any particular anonymized answer. The demographic data captured in step 304 can be used, for example, to support dating-oriented distribution criteria (for example, distributing prompts according to gender preference settings), to support networking-oriented prompts and redistribution (for example, aligning participants with similar business interests), and to support the format in which a participant later submits an identity guess (for example, selecting a name from a roster, selecting an avatar, or selecting a profile card). In virtual implementations, at least some demographic data, such as age or a profile picture, may be selectively displayed in the environment during the hunt phase as limited discovery cues, while still preserving the essential anonymity of the received answer content until match validation occurs.

In step 306 (intent and preference setup), the system receives a participant's intention for participating in the session, which intention drives question selection and influences subsequent redistribution criteria and the overall user experience. In step 306, the participant may specify one or more intentions such as dating, friendship formation, general socializing, community engagement, or networking, and may also specify intention variants such as investing, seeking investors, or seeking a technical founder where the networking context involves learning about growth, achievements, or alignment to build interpersonal trust. Step 306 reflects that the disclosed system is designed for social settings where participants aim to get to know each other through structured interactions and is not intended for transactional or commercial environments dominated by direct sales, consultations, or negotiations. Accordingly, step 306 may also be used to classify the session type so that the system can select reflective and nostalgic prompts that evoke emotion and trust in dating and social contexts, while selecting career-and challenge-oriented prompts in networking contexts, thereby improving meaningful engagement over superficial introductions. Step 306 may further establish the verification criteria used later during match confirmation, such that the system can validate a match based on the submitted guess and the secure mapping between anonymized response identifiers and participant identifiers maintained by the server.

In step 308 (preference toggle and filter configuration), the system enables the participants to configure or toggle optional filters and preferences that control how anonymized answers are redistributed and how compatibility is pre-filtered. Step 308 may include enabling or disabling dating preferences, such as straight, gay, or bisexual filters, and may include configuring other criteria relevant to the participant's stated intention, such as interest categories, networking focus areas, or other compatibility signals. The toggles and filter configuration may be stored as participant preference metadata and used by the assignment and redistribution module (for example, the module 106C of FIG. 1) to perform flexible distribution, such as distributing anonymized prompts based on gender preferences for dating, distributing prompts to users with similar business interests for networking, or applying randomization when filters are disabled or when no preference criteria is set. Step 308 may also include fairness constraints and random number generation controls that prevent bias and reduce repetitive pairing patterns, and may include session-level configuration to ensure that each participant receives another participant's anonymized answer (not their own) and that a multi-participant pool is maintained to preserve the hunt dynamic in which multiple wrong guesses are possible and expected. In some implementations, step 308 further cooperates with safety features by allowing a participant to block certain interactions or report inappropriate behavior, while preserving the anonymity and integrity of the game until a match is confirmed and an identity revelation trigger is executed for the correct pair.

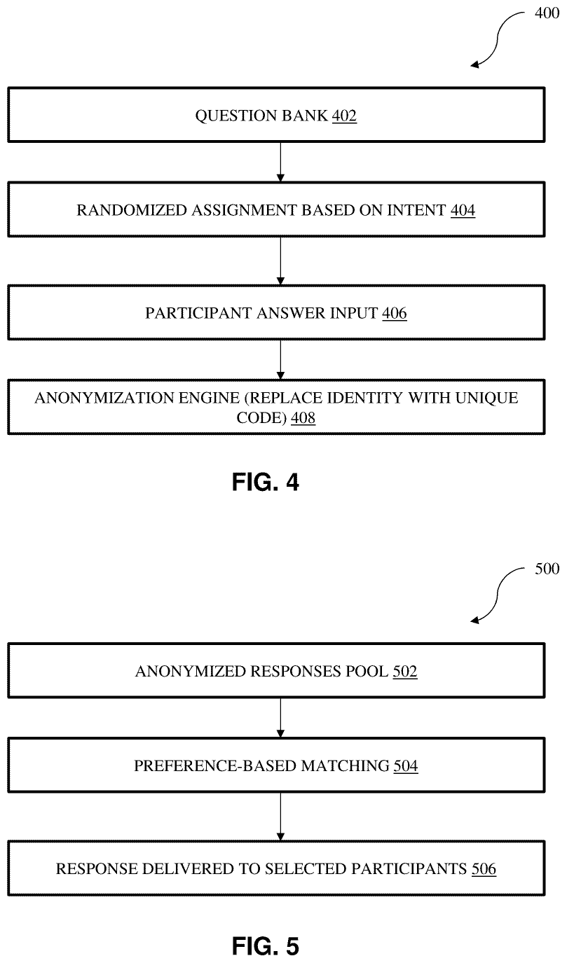

FIG. 4 illustrates a question assignment and response anonymization process 400 used to protect participant identity, in accordance with an exemplary embodiment of the present invention. The example question-and-answer generation pipeline may be executed by the application server (for example, the application server 106 of FIG. 1) in cooperation with the user profile management module, the question bank, and the anonymization engine, and corresponds generally to the assign/receive/anonymize stages shown in steps 204, 206, and 208 of FIG. 2. The steps shown in FIG. 4 operationalize personalized question curation and participant-generated answer creation while preserving the essential anonymity requirement that enables the later hunt process, such that the system can elicit meaningful self-expression, reduce approach anxiety, and generate authentic conversation “currency” that will be redistributed to other participants in the same session based on intent and compatibility criteria.

In step 402 (question bank), the system maintains and accesses a centralized repository of the curated questions that are organized, tagged, or otherwise associated with different social environments and participant intentions. The question bank in step 402 may include, by way of example, prompts for dating and socializing that are reflective, nostalgic, and emotional to evoke memories and foster interpersonal trust, as well as prompts for networking scenarios that focus on career achievements, growth experiences, and professional challenges to help participants learn about each other's development and build trust or alignment. The question bank may further include prompts usable for community engagement and team-building exercises, where structured interactions are desired to help participants get to know each other beyond superficial introductions. Although the repository may also include question types that are factual in nature, the disclosed system is not intended for transactional or commercial environments dominated by direct sales, consultations, or negotiations, because the effectiveness of the invention relies on users'intent to engage in meaningful personal interactions rather than exchanging information unrelated to either user. In operation, the question bank may store metadata for each question (for example, intention category, difficulty level, emotional tone, sensitivity level, and fairness or rotation controls) to support tailored selection and to prevent repetitive or biased prompt exposure across sessions.

In step 404 (randomized assignment based on intent), the system assigns the one or more questions to the participants using a selection mechanism that accounts for each participant's stated intention and optionally their preferences, while also employing randomization to promote fairness and reduce predictable patterns. In step 404, the system may first determine an intention class (for example, dating, socializing, friendship formation, networking) based on onboarding information, and then select questions from the portion of the question bank corresponding to that intention class. The system may further apply fairness constraints, such as preventing the same participant from repeatedly receiving the same prompt across rounds, balancing question types across a participant pool, and avoiding systematic biases that could disadvantage certain participants. In some implementations, step 404 includes initiating a timer or response window to regulate the answering phase and maintain session momentum, and the system may also support multiple rounds in which different questions are assigned over time. Step 404 thereby ensures that questions are not generic or purely entertainment-oriented but instead are curated and assigned to elicit answers that meaningfully reflect personality, values, interests, growth, or experiences, depending on the social environment.

In step 406 (participant answer input), the system receives the participant-generated responses to the assigned questions via an input interface on the user device. In step 406, participants compose and submit answers within a specified time frame, and the submitted answers become the core content used to drive subsequent interactions. The participant-generated nature of the answers is essential because it provides authentic self-expression and creates natural conversation starters that can be leveraged after match discovery, thereby increasing depth relative to profile-only matching and reducing the likelihood that conversations remain superficial. Step 406 may include associating each answer with a participant identifier and session identifier for internal tracking, storing submission timestamps and question identifiers, validating that the response is complete and within permitted formatting constraints, and recording delivery confirmations indicating that the participant received the prompt and successfully submitted an answer. In some implementations, participants may submit multiple answers across multiple questions per session, and the system may maintain round state so that redistribution and hunt phases can be synchronized across the participant pool.

In step 408 (anonymization engine-replace identity with unique code), the system anonymizes each submitted response by removing or masking identifying information and replacing author identity with a system-generated unique code, thereby establishing a dissociation between answer content and participant identity during the pre-discovery phase. In some implementations, anonymized responses and associated identity mappings may be encrypted at rest and during transmission to further protect participant privacy. In step 408, the system may generate an anonymized response identifier (for example, an alphanumeric code) that is stored with the response content and used for redistribution, while separately and securely storing a mapping between the anonymized response identifier and the originating participant identifier in a database. The anonymization engine may further replace, or strip personally identifiable information contained within the response itself, to the extent feasible, while preserving the semantic value of the answer so that it remains useful for the hunt and for post-discovery conversation. Step 408 is foundational because anonymity is the mechanism that eliminates immediate rejection risk and creates the mystery that motivates the hunt; without anonymity, the interaction would resemble conventional profile browsing or direct messaging and would not create the same structured, low-risk approach pathway. Step 408 may also log anonymization events, enforce access controls that prevent identity resolution until a match is validated, and cooperate with safety features such as reporting or blocking without revealing author identity prematurely.

FIG. 5 illustrates a redistribution process 500 for assigning anonymized participant responses based on predefined preferences, in accordance with an exemplary embodiment of the present invention. The example redistribution and delivery workflow in which anonymized participant-generated responses are pooled, evaluated against intent-driven and preference-driven criteria, and then delivered to selected other participants within the same session to initiate the hunt phase. FIG. 5 corresponds generally to step 210 of FIG. 2 and may be implemented by the assignment and redistribution module (for example, the module 106C of FIG. 1) operating in cooperation with the anonymization engine (for example, the engine 106D), the user profile management module (for example, the module 106A), and the database (for example, the database 108). The operations shown in FIG. 5 are central to the inventive concept because they preserve multiple essential elements simultaneously, namely that participant-generated answer content is distributed anonymously, that answers are distributed to other participants (not to the author), that the distribution occurs within a multi-participant session to preserve the search dynamic, and that the distribution is compatibility-based or criteria-based so that recipients perceive the answer as coming from a potentially compatible match and are motivated to actively search for the author.

In step 502 (anonymized responses pool), the system aggregates the anonymized responses created during the answer submission and anonymization stages into a pool associated with a particular session and, in some implementations, a particular round within the session. In step 502, each response in the pool is stored and referenced using a system-generated unique code rather than the author's identity, and the pool may include metadata such as session identifiers, round identifiers, question identifiers, timestamps, and any applicable intention tags corresponding to the prompt type. The pool may be formed only from participant-generated answers authored by real participants in the same active session, because the authenticity of the content is required for meaningful post-discovery conversation and for the hunt to result in a genuine connection rather than a purely artificial or pre-scripted interaction. Step 502 may further include excluding responses that fail validation checks, applying fairness constraints (for example, ensuring that each participant has at least one response available for redistribution), and maintaining a secure internal mapping between the anonymized response codes and the originating participant identifiers, such mapping being inaccessible to other participants until a later match confirmation event triggers identity revelation.

In step 504 (preference-based matching), the system determines which anonymized responses from the pool should be delivered to which recipients based on intent-driven and preference-driven criteria, and optionally based on additional compatibility analysis using participant profiles, interests, and/or their own answers. In an example dating scenario, step 504 may apply filters configured during onboarding, such as gender preferences and dating preference toggles (for example, straight, gay, bisexual), to ensure that redistributed answers are sent to recipients for whom the unknown author is more likely to be relevant, thereby increasing motivation to hunt and reducing perceived randomness. In an example networking scenario, step 504 may match based on similar business interests, alignment signals, growth goals, achievements, or professional challenge themes, such that the redistributed answer content is more likely to reflect a meaningful point of connection and trust-building rather than superficial small talk. Where no filter is applied or where a user disables preference constraints, step 504 may apply randomization, including a random number generator and fairness controls, to assign responses in a manner that avoids systematic bias, prevents repetitive pairing loops, and maintains broad participation across the pool. Step 504 may also enforce integrity constraints such as preventing a participant from receiving their own response, preventing the same anonymized response from being delivered to an excessive number of recipients unless explicitly configured, and ensuring that each participant receives at least one anonymized response to enable active engagement during the hunt phase. In some implementations, step 504 creates a distribution map that explicitly records which anonymized response code is assigned to which recipient participant identifier for later verification, scoring, and auditability.

In step 506 (response delivered to selected participants), the system transmits the assigned anonymized response(s) to the selected recipient participants through their user devices and records delivery confirmations to ensure the distribution was completed as intended. In step 506, the response is delivered without identifying information about the author, and the recipient is provided with the answer content and optionally with gameplay guidance indicating that the recipient's objective is to locate the author within the same session through interaction and verification. The delivery may include a time window for the hunt phase, reminders or notifications to initiate searching, and presentation formatting that preserves the semantic value of the response as a conversation starter. Step 506 may further include logging the delivery event, including timestamps and acknowledgements that the recipient opened or viewed the response, which supports later scoring, feedback, and integrity checks. In virtual implementations, step 506 may be synchronized with avatar-based environment controls such that the response is delivered at the beginning of a round and the environment is then enabled for proximity-based interactions, voice chat, or messaging to support searching. In in-person implementations, step 506 may be synchronized with an event host's session timing so that all participants begin hunting within a common window, thereby maintaining urgency and engagement while avoiding the linear, one-at-a-time structure of conventional speed dating. Step 506 thereby initiates the core hunt dynamic by providing each recipient with another participant's anonymized, compatibility-relevant answer content, which creates a low-risk and structured reason to approach multiple people, supports multiple “verification interactions” that build comfort and social momentum, and ultimately culminates in match discovery and identity revelation upon successful validation.

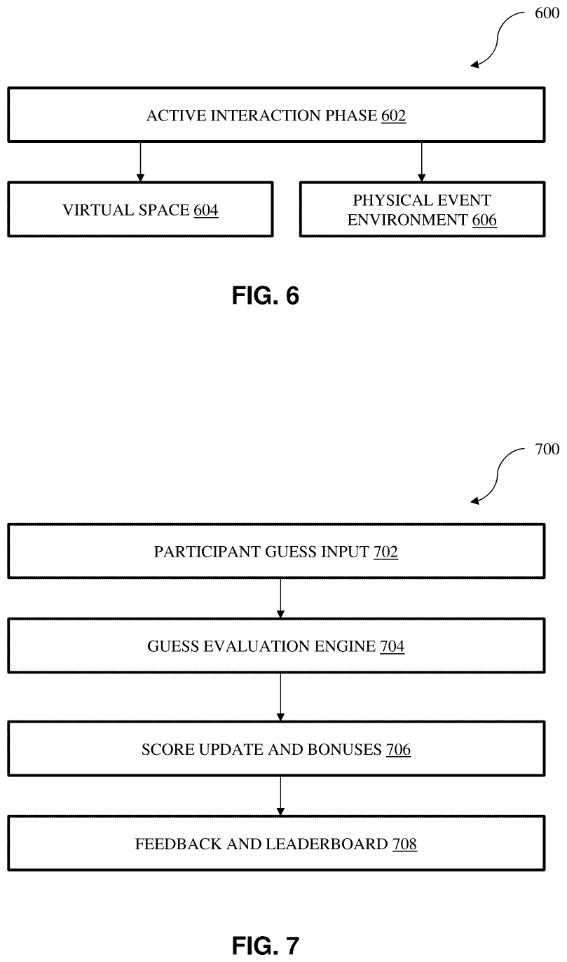

FIG. 6 illustrates an interaction phase 600 enabling participant engagement in both virtual environments and in-person events, in accordance with an exemplary embodiment of the present invention. The example interaction-stage architecture may be executed after the anonymized answers have been redistributed (for example, after step 210 of FIG. 2 and step 506 of FIG. 5) and corresponds generally to step 212 of FIG. 2, in which the participants actively engage in a structured “hunt” to identify the author of an anonymized response received from a potentially compatible match within the same session. FIG. 6 emphasizes that the disclosed invention is adaptive to multiple social environments and is operable in either (i) a virtual implementation, including 2D and 3D spaces with proximity-based interactions, or (ii) a physical in-person implementation, such as a café or hosted social event, while preserving the essential elements that drive reduced approach anxiety, increased engagement, and trust-building. In the illustrated flow, the system transitions from content generation and anonymous redistribution to an active interaction phase 602, in which the anonymized answer content serves as the structured conversation starter and the hunt process converts passive matching into motivated interpersonal discovery.

In step 602 (active interaction phase), the system initiates and manages a bounded period during which the participants attempt to locate and verify the author of the anonymized answer(s) they received. In step 602, the system may transmit instructions to the user devices regarding game objectives, permissible interaction rules, and timing constraints, and may activate a timer to regulate the interaction window and maintain engagement across rounds. The active interaction phase 602 is intentionally structured so that participants have a legitimate and low-risk reason to approach multiple people, because the verification interaction is framed as part of a game rather than as a personal advance, and wrong guesses are treated as expected gameplay events rather than explicit social rejection. Step 602 may include participant tracking and interaction monitoring to determine whether a participant has attempted interactions, whether multiple guesses have been made, and whether a correct match has been discovered, thereby supporting integrity controls such as preventing duplicate distributions, preventing repeated validation of the same match, and maintaining fairness across participants. Step 602 may further support optional hint or clue generation, for example by providing progressive clues to a participant who is not making progress, while still preserving anonymity until the system validates a correct match and triggers identity revelation. Step 602 also supports the transition to post-discovery conversation by ensuring that, once a match is confirmed, the answer content and shared hunt experience can serve as immediate shared context, enabling deeper engagement beyond superficial introductions.

In step 604 (virtual space), the system implements the active interaction phase within a virtual environment that may be rendered on the user devices as a 2D or 3D space in which participants interact using avatars. In step 604, the virtual space may support proximity-based interactions such that communication channels (for example, voice chat or messaging) are enabled or prioritized when avatars are within a defined distance, thereby mimicking real-world social dynamics and reducing the friction and fatigue associated with conventional video-based events. The virtual space may selectively display limited participant attributes, such as age, profile picture, interests, or experience, to assist discovery while maintaining that the anonymized answer content remains dissociated from identity until a correct verification occurs. Step 604 may include virtual room or zone logic that supports bounded “cafés,” tables, or networking areas to increase serendipitous encounters and to encourage participants to move and engage rather than passively wait. The system may log interaction attempts within the virtual space, such as the number of unique participants approached, the duration of each interaction, and the timing of submitted guesses, and may use the monitoring to support optional hinting or to maintain engagement through session control. Step 604 thereby preserves the core hunt dynamic-active searching for an unknown compatible author-while providing an adaptive environment that can be deployed remotely or scaled to large participant pools.

In step 606 (physical event environment), the system implements the active interaction phase within an in-person setting such as a cafe, social event, community gathering, or team-building session, where participants are physically co-located and use their user devices to receive anonymized answers and to submit guesses and confirmations. In step 606, the system may provide structured prompts and guidance that instruct recipients to approach others and ask a verification question, such as “Did you write this?”, thereby providing a low-risk and natural conversation starter. The system may regulate interaction timing using session timers, round timing controls, or host-driven announcements, which maintain urgency and engagement while avoiding the linear, sequential one-person-at-a-time structure characteristic of conventional speed dating. Step 606 may further include participant tracking to prevent duplicate distributions and to confirm that each participant remains in the active pool during the session and may support safety features such as blocking or reporting of inappropriate behavior while the anonymity constraints remain in effect until match validation. By framing interactions as part of a hunt, step 606 reduces approach anxiety, encourages multiple “mini interactions” that build social momentum, and increases the perceived value of a discovered match due to effort investment, after which the matched parties can naturally transition into a deeper conversation based on the disclosed answer content and the shared session experience.

FIG. 7 illustrates a guess submission, scoring, and feedback workflow 700 for evaluating participant interactions, in accordance with an exemplary embodiment of the present invention. The example verification, scoring, and feedback workflow 700 may be performed after or during the active interaction phase (for example, step 212 of FIG. 2) and corresponds generally to receiving the identity guesses and producing scoring and feedback outputs (for example, steps 214 and 216 of FIG. 2). FIG. 7 may be implemented by the application server (for example, the application server 106 of FIG. 1) using the assignment and redistribution module, the anonymization engine, the scoring and leaderboard module, and the feedback engine in cooperation with the database 108 that stores the secure mapping between anonymized response codes and author identities. The steps of FIG. 7 preserve the essential requirement that identity remains unrevealed during the hunt and is revealed only upon successful match confirmation, thereby providing payoff and closure to the hunt while enabling a transition from gameplay to genuine conversation grounded in the participant-generated answer content.

In step 702 (participant guess input), the system receives a guess submission from a participant attempting to identify the author of an anonymized response that the participant previously received. Step 702 may occur after a verification interaction, such as the participant approaching another person in a physical event environment and asking, “Did you write this answer?” or, in a virtual space, initiating an avatar-based conversation and then selecting the likely author through the user interface. The guess input may be submitted as a selection of a participant name from a session roster, a selection of an avatar or profile card, or an identification of particular author-related information permitted by the session rules, such as identifying professional goals in a networking scenario. Step 702 may include capturing metadata such as timestamps, the anonymized response identifier being guessed, the session or round identifier, and the number of prior attempts, and may further include logging whether the participant acknowledged game instructions or completed required interaction steps before submitting the guess. Step 702 thereby provides the system with an explicit, machine-evaluable representation of the participant's discovery attempt while maintaining the anonymity constraints until validation occurs.

In step 704 (guess evaluation engine), the system evaluates the submitted guess to determine whether the guess corresponds to the correct author of the anonymized response and, if so, validates the match. In step 704, the system may access the secure mapping between the anonymized response code and the originating participant identifier stored in the database and compare the mapping output to the guessed identity, while enforcing access controls such that identity resolution is performed only by the server-side evaluation logic. Step 704 may also enforce integrity constraints, such as preventing a participant from guessing themselves as the author, preventing repeated confirmation of an already-confirmed match, and ensuring the guess is associated with an anonymized response that was actually delivered to the guessing participant (thereby preventing gaming of the scoring system). When a match is validated, step 704 may generate a match confirmation event that triggers the identity revelation mechanism to both parties, providing the closure and payoff that is essential to the hunt dynamic and enabling the transition into post-discovery conversation using the answer content as a contextual starter.

In step 706 (score update and bonuses), the system updates the participant score responsive to the evaluation outcome and applies any configured bonuses to promote engagement and sustained participation across rounds. For example, step 706 may award points for a correct identification and may apply additional bonus points for consecutive correct guesses, faster match discovery within a round timer, or completion of a hunt cycle within a defined interaction window. Step 706 may also record score events and scoring rationale to the database for auditability and later analytics and may update per-session statistics such as total attempts, accuracy rates, average time-to-match, and other engagement metrics. Step 706 thereby supports optional gamification modules while preserving the core social purpose of the invention, namely converting anonymous content into active interpersonal discovery and meaningful connection in a bounded session.

In step 708 (feedback and leaderboard), the system provides the feedback outputs to participants and optionally updates and presents a leaderboard reflecting scores or achievements. The feedback in step 708 may include confirmation of a correct match, notification of identity revelation to both matched parties, and user interface outputs that encourage the parties to engage in conversation using the received answer as a starting point. Where the guess is incorrect, step 708 may provide non-punitive feedback consistent with the game framing, thereby maintaining low-risk social engagement and encouraging continued interaction attempts without the pressure associated with face-to-face rejection. Step 708 may also collect participant feedback at appropriate times, such as after match confirmation or at session conclusion, including ratings of prompt quality, perceived compatibility, and overall experience, which feedback may be stored and used by the system to optimize question curation, distribution criteria, and session timing in future sessions.

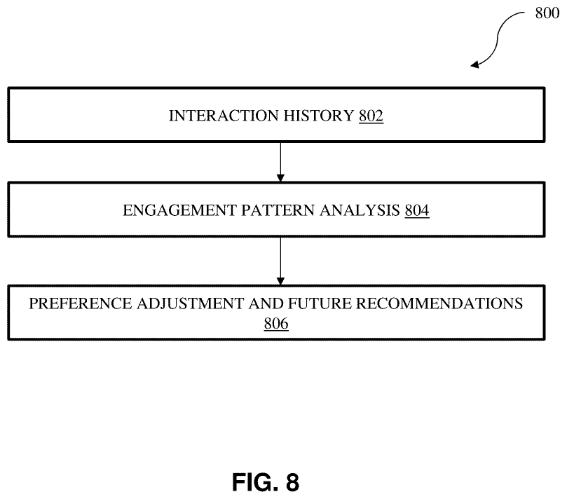

FIG. 8 illustrates a process flow 800 for dynamic adjustment of participant preferences based on prior interactions and engagement patterns, in accordance with an exemplary embodiment of the present invention. The example analytics and optimization workflow may be performed by the application server (for example, the application server 106 of FIG. 1) using the feedback engine and/or an analytics engine in cooperation with the database, to improve future sessions while preserving the core session-bounded hunt mechanics and anonymity constraints described above. In the illustrated arrangement, the system collects and processes interaction and outcome data generated during onboarding, question assignment, answer submission, anonymized redistribution, the active interaction phase, guess submissions, match confirmations, scoring, and participant feedback, and then uses that information to adjust preference defaults and provide future recommendations that enhance engagement, trust-building, and perceived compatibility without converting the system into a passive profile-browsing or unstructured messaging experience.

In step 802 (interaction history), the system stores and maintains the history of participant interactions and session outcomes in the database 108, including data created during one or more completed sessions. Step 802 may include, for each participant and/or session, records such as the participant's stated intention, enabled preference toggles and filters, assigned question categories, response submission timestamps, anonymized response identifiers delivered to the participant, delivery confirmations, interaction attempts logged during the hunt phase (for example, number of unique people approached, number of verification interactions performed, duration of interaction windows used), guess submission events, correctness outcomes, match confirmation events, and scoring events including any bonuses for consecutive correct guesses. In virtual implementations, step 802 may further include environment-specific interaction signals such as proximity-based contact events, avatar movement patterns within the 2D/3D space, initiation of voice chats or messages, and round timing compliance, whereas in physical implementations step 802 may include device-driven indicators such as when a participant opened a received anonymized answer, when a guess was submitted, and session timer milestones. Step 802 thereby creates a durable, machine-readable record of how the invention performed in practice for different social environments, while preserving privacy by storing identity-resolution mappings in a secured manner and by limiting the exposure of any sensitive mappings to server-side verification logic.

In step 804 (engagement pattern analysis), the system analyzes the interaction history to identify engagement patterns, effectiveness indicators, and potential optimization opportunities for future sessions. Step 804 may compute metrics such as overall match discovery rate, average time-to-match, number of attempts per successful match, distribution fairness statistics (for example, whether participants consistently received redistributed answers and whether self-delivery was prevented), and the impact of different question types (for example, reflective and nostalgic prompts versus other categories) on successful post-discovery conversations and trust-building. Step 804 may also analyze how different intent settings and filter configurations affected engagement, such as whether dating preference filters increased perceived value of hunts, whether networking criteria based on shared interests produced higher-quality conversations, or whether fully randomized distribution reduced motivation. In some implementations, step 804 also evaluates session-level parameters such as round timing, interaction window duration, hint usage (where implemented), and safety events (for example, blocks or reports), thereby enabling the system to identify configurations that increase meaningful engagement while continuing to avoid the shortcomings of conventional systems, such as passive swiping, unstructured digital initiation, superficial matching, and lack of real-world or session-based transition.

In step 806 (preference adjustment and future recommendations), the system generates the adjustments and recommendations that can be applied to subsequent sessions for the same participant or for future session configurations, while maintaining the essential elements of anonymous redistribution, compatibility-based motivation, multi-participant hunt dynamics, and identity revelation upon successful match confirmation. Step 806 may include recommending changes to preference toggles, such as enabling or disabling certain filters, suggesting networking interest categories to refine compatibility-based redistribution, or recommending particular session types (for example, socializing versus networking) based on observed engagement patterns. Step 806 may also include recommending question categories that are likely to foster trust and meaningful conversations for a given participant intention, such as prioritizing reflective, nostalgic, and emotional prompts for dating or friendship contexts, and prioritizing growth-and achievement-oriented prompts for networking contexts. Step 806 may further recommend session parameters such as interaction window lengths or the number of prompts per round, and may optionally recommend the use of gamification settings, leaderboards, or hint mechanisms where such features improved engagement in prior sessions. Step 806 may be implemented such that it enhances user experience without replacing the hunt process with passive selection or direct attribution of answers to identities, because the invention's effectiveness relies on preserving anonymity prior to match validation, distributing answers to other participants rather than self-selection, and requiring active interpersonal discovery within a bounded multi-participant session.

The foregoing description illustrates that the present invention provides a comprehensive, structured, and privacy-preserving framework for transforming social interaction into an engaging, goal-oriented, and psychologically motivating experience. At its core, the invention introduces a method and system for facilitating a social interaction game in which one or more participants are guided through a sequence of well-defined stages that collectively reduce social anxiety, improve the efficiency of discovering compatible connections, and promote meaningful engagement. Unlike unstructured social environments or passive digital platforms, the invention deliberately combines anonymity, compatibility-driven distribution, active participation, and identity revelation to create a complete interaction lifecycle that transitions naturally from a game format into genuine human connection.

In an initial stage, the invention operates through a user onboarding and profile setup process. The participants provide the profile data, including name, age, gender, profile picture, and stated interaction intentions such as dating, networking, socializing, investing, or seeking collaborators. The intentional framing is fundamental to the invention, as it assumes that the participants enter social environments with a purpose, even if that purpose differs across participants. The collected data is not merely descriptive but directly informs subsequent stages, including question selection, compatibility analysis, and verification criteria. The participants are further empowered through preference controls that allow them to toggle filters, such as gender preferences or interest-based criteria, enabling a tailored yet flexible interaction experience without forcing rigid constraints. Following onboarding, the system initiates the question assignment stage driven by a centralized question generation system. A curated database stores the questions aligned with different social contexts, including reflective and nostalgic prompts for dating or socializing, professional growth-oriented questions for networking, and factual prompts for product-or service-related interactions where applicable. The questions are assigned using the randomization algorithm that enforces fairness and prevents bias, ensuring that no participant is advantaged or disadvantaged by repeated exposure to specific question types. The structured question presentation establishes a shared framework for self-expression and ensures that all generated content has relevance and conversational value. The participants then enter an answer submission stage, during which they compose and submit the responses within a defined time window. These responses form the primary content currency of the game and are intentionally participant-generated rather than system-generated. The requirement is essential, as authentic self-expression is the foundation for meaningful connection. Pre-written or automated content would undermine the personal investment and conversational depth that the invention seeks to foster. Submitted responses are stored with participant identifiers solely for internal processing and verification purposes.

An important stage of the present invention is the anonymization and secure storage of the participant responses. The personally identifiable information is removed and replaced with system-generated codes, and responses are encrypted and securely stored. The anonymization is not a peripheral feature but a core structural element that eliminates immediate rejection risk and reduces approach anxiety. By decoupling content from identity at this stage, the invention creates a sense of mystery and safety that motivates engagement while preserving privacy. Once anonymized, the responses are processed by a compatibility matching engine and redistributed to other participants through an anonymous distribution system. Distribution is never self-referential; the participants always receive responses authored by others, which inherently necessitates interpersonal interaction. The redistribution algorithm may consider factors such as stated intentions, gender preferences, business interests, or other criteria, while also incorporating randomization to maintain fairness. The compatibility-based or algorithmic distribution is essential because it creates a belief that the received answer originates from a potentially meaningful match, thereby increasing motivation to search for the author. After redistribution, the hunt phase is activated. The participants are encouraged to actively search for the original author of the response they received by engaging with multiple other participants. The hunt may occur in virtual environments, such as 2D or 3D spaces with avatar-based interactions and proximity-based voice communication, or in physical environments, such as cafes or events, where structured prompts guide conversations. A timer regulates the duration of the phase, ensuring balanced participation, urgency, and sustained engagement. The hunt transforms passive waiting into active social exploration and creates a legitimate, low-risk reason to approach others. During the hunt, the participants engage in verification interactions, often by asking structured questions such as whether another participant authored a particular response. These interactions are intentionally framed as part of the game, making incorrect guesses socially acceptable and even expected. Each interaction builds familiarity, reduces social barriers, and increases comfort, regardless of whether it results in a correct match. System-level participant tracking ensures fair play, prevents duplicate distributions, and maintains game integrity.

When a participant successfully identifies the author of a received response, the system performs a match confirmation and identity revelation step. This step validates the match and reveals identities to both parties. The identity revelation is a crucial concluding mechanism of each hunt cycle, as it provides psychological payoff and closure for the effort invested. Without this revelation, the interaction would lack resolution and fail to transition meaningfully from game to genuine connection. The moment of discovery is reinforced by the sunk-cost effect, wherein the effort expended during the hunt increases the perceived value of the matched individual. Following the identity revelation, the invention supports a natural transition into post-discovery conversation. The answer content itself serves as a substantive conversation starter, enabling the participants to bypass superficial small talk and immediately engage in deeper, more meaningful discussion. The shared experience of the game further strengthens rapport and trust, allowing the interaction to evolve organically beyond the structured framework.

The invention further incorporates the scoring and feedback system that evaluates the participant guesses and interactions. Points may be awarded for correct identifications, with bonuses for consecutive successes and penalties for incorrect attempts. Leaderboards, badges, or other gamification elements may be provided to encourage continued engagement. Feedback mechanisms analyze participant behavior, engagement patterns, and success rates to generate personalized recommendations and dynamically adjust preferences or difficulty levels over time. These adaptive features enhance long-term engagement while preserving user autonomy.

From a system perspective, the invention integrates multiple cooperating components, including user interfaces, backend servers, databases for profiles and responses, communication systems for notifications and confirmations, and analytics engines for optimization. Optional enhancements, such as hint systems, time management controls, safety features for blocking or reporting, and feedback collection tools, further strengthen usability and trust without altering the core inventive concept. The invention is defined by several essential elements that cannot be removed or replaced without undermining its function. These include anonymous answer distribution, distribution of answers to other participants, the active physical or virtual hunt process, participant-generated content within the same session, identity revelation upon successful match, participation by multiple users within a shared session, and compatibility-based or algorithmic distribution. Together, these elements solve the fundamental problems of approach anxiety, inefficient discovery, and low-effort engagement that persist in conventional social interaction systems. The invention is particularly suited to social events, community gatherings, team-building activities, and personal relationship development, including dating and friendship formation, as well as non-transactional networking scenarios. The invention is not intended for purely transactional or commercial environments where meaningful personal interaction is not the objective. By combining structured interaction, privacy preservation, gamification, and adaptive social environments, the present invention establishes a novel and holistic approach to facilitating authentic human connection across both virtual and physical settings.

The present invention provides numerous technical and experiential advantages over existing social interaction mechanisms by transforming unstructured and anxiety-driven social environments into a guided, engaging, and privacy-preserving discovery process. A primary advantage is the reduction of approach anxiety through anonymous answer distribution, which removes the fear of immediate rejection and provides participants with a legitimate, low-risk reason to initiate conversations. The compatibility-based redistribution of participant-generated answers significantly improves the efficiency of discovering meaningful connections by increasing the likelihood that interactions occur between individuals with aligned interests, values, or intentions. The hunt-based interaction model promotes active participation rather than passive browsing, ensuring higher engagement and filtering out low-effort users. The use of participant-generated content creates authentic conversation starters that enable deeper interactions from the outset, while the identity revelation upon successful match provides psychological closure and reinforces perceived value through effort investment. The invention further benefits from adaptability across both virtual and physical environments, including avatar-based proximity interactions and in-person structured prompts, making it versatile across diverse social contexts. Additional advantages include enhanced privacy through encryption and anonymization, fairness through randomized and bias-preventing assignment algorithms, sustained engagement through timed interaction phases and dynamic scoring mechanisms, and long-term optimization via feedback-driven preference adjustment. Collectively, these advantages result in a more meaningful, trustworthy, and effective social interaction framework that improves user experience, engagement quality, and the likelihood of forming genuine connections.

The foregoing descriptions of specific embodiments of the present technology have been presented for purposes of illustration and description. They are not intended to be exhaustive or to limit the present technology to the precise forms disclosed, and obviously many modifications and variations are possible considering the above teaching. The embodiments were chosen and described to best explain the principles of the present technology and its practical application, to thereby enable others skilled in the art to best utilize the present technology and various embodiments with various modifications as are suited to the particular use contemplated. It is understood that various omissions and substitutions of equivalents are contemplated as circumstance may suggest or render expedient, but such are intended to cover the application or implementation without departing from the spirit or scope of the claims of the present technology. While several possible embodiments of the invention have been described above and illustrated in some cases, it should be interpreted and understood as to have been presented only by way of illustration and example, but not by limitation. Thus, the breadth and scope of a preferred embodiment should not be limited by any of the above-described exemplary embodiments

What is claimed is:

1. A method for facilitating a social interaction game among participants within a bounded session, the method comprising:
collecting, by a computing system, user profile data for each participant, the user profile data including at least a name, age, gender, profile picture, and an interaction intention selected from dating, networking, or general socializing;
assigning, by the computing system, one or more questions to each participant based on the selected interaction intention using a randomized selection process configured to ensure fairness and reduce assignment bias;
receiving participant-generated responses to the assigned questions;
anonymizing the received responses by dissociating the responses from participant identities and associating each response with a system-generated identifier;
redistributing anonymized responses to other participants within the same session based on predefined distribution criteria;
facilitating participant interactions in at least one of a virtual environment or a physical event environment using structured interaction prompts;
receiving participant guesses identifying an author of a redistributed anonymized response; and
awarding points and providing feedback based on correctness of the participant guesses.

2. The method of claim 1, wherein redistributing anonymized responses is performed based on compatibility criteria including at least one of gender preferences, business interests, social alignment factors, or product-related categories.

3. The method of claim 1, wherein the anonymizing step comprises replacing personally identifiable information with unique system-generated codes and storing a secure mapping between the codes and participant identities.

4. The method of claim 1, wherein facilitating participant interactions comprises enabling proximity-based communication features within a virtual two-dimensional or three-dimensional environment.

5. The method of claim 1, wherein facilitating participant interactions comprises providing structured prompts in a physical event environment that guide participants to initiate verification interactions with other participants.

6. The method of claim 1, wherein the method further comprises enabling participants to toggle preference filters to enable or disable specific compatibility criteria prior to redistribution of anonymized responses.

7. The method of claim 1, wherein facilitating participant interactions includes activating a timer to regulate a duration of an interaction phase within the session.

8. The method of claim 1, wherein awarding points comprises applying bonus points for consecutive correct identifications.

9. The method of claim 1, further comprising analyzing interaction history and engagement patterns to generate recommendations for future sessions.

10. The method of claim 9, wherein the recommendations include adjusting question categories, preference filters, or interaction parameters to improve engagement in subsequent sessions.

11. A system for conducting a social interaction game among a plurality of participants, the system comprising:
one or more processors; and
a memory storing instructions that, when executed by the one or more processors, cause the system to:
collect and store user profile data including demographic information and interaction intentions;
access a question bank;
select and assign questions from the question bank based on participant intentions using a randomized fairness-based process;
receive participant-generated responses;
anonymize the responses by replacing identifying information with system-generated identifiers;
redistribute anonymized responses to other participants according to predefined distribution criteria;
facilitate structured participant interactions in virtual and physical environments;
receive guesses identifying authors of anonymized responses; and
evaluate guesses and generate scoring and feedback outputs.

12. The system of claim 11, wherein the question bank includes distinct question sets tailored for dating, networking, and general social interaction contexts.

13. The system of claim 11, wherein the system further comprises a user profile management module configured to store demographic data, preferences, and interaction intentions.

14. The system of claim 11, wherein the system further comprises an anonymization engine configured to dissociate participant identities from responses and securely maintain identity mappings.

15. The system of claim 11, wherein the redistribution of anonymized responses is performed using a matching algorithm configured to apply compatibility filters or randomization when filters are disabled.

16. The system of claim 11, wherein the system further comprises a communication interface configured to support proximity-based voice, text, or avatar interactions in a virtual environment.

17. The system of claim 11, wherein the communication interface is further configured to support structured interaction prompts during in-person social events.

18. The system of claim 11, wherein the system further comprises a scoring engine configured to award points, apply bonuses for consecutive correct guesses, and generate leaderboard rankings.

19. The system of claim 11, wherein the system further comprises a feedback engine configured to analyze participant engagement patterns and generate personalized recommendations.

20. The system of claim 19, wherein the feedback engine dynamically adjusts user preferences, question selection, or redistribution criteria based on prior session outcomes.
